(19) United States
(12) Patent Application Publication
(10) Pub. No.: US 2007/0161512 A1
(43) Pub. Date: Jul. 12, 2007

(54) Agricultural pesticide compositions

(76) Inventors: Frances George Smith, Robbinsville, NJ (US); Rajesh Pazhianur, Yardley, PA (US)

Correspondence Address: KEVIN E. MCVEIGH;RHODIA INC., CN 7500, 8 CEDAR BROOK DRIVE, CRANBURY, NJ, 08512, US

(21) Appl. No.: 11/646,721

(22) Filed: Dec. 28, 2006

Related U.S. Application Data
(60) Provisional application No. 60/754,834, filed on Dec. 29, 2005.

(51) Int. Cl. A01N 57/18; A01N 25/10

(52) U.S. Cl. 504/207; 504/360; 424/405

(57) ABSTRACT

An aqueous agricultural pesticide composition contains: (a) a water soluble or water dispersible deposition control agent, in an amount effective to provide improved anti-rebound properties and selected from: (i) dextrins and tamarind gums, (ii) derivatized polysaccharide hydrocolloids, except derivatized guars, having a molecular substitution of greater than or equal to about 0.1, (iii) proteinaceous hydrocolloids, (iv) lignins and lignin derivatives, except alkali metal, alkaline earth metal or ammonium lignosulphonates, and (v) lipid polymers, and (b) an effective amount of a pesticide.

### FIELD OF THE INVENTION

The invention relates to agricultural pesticide compositions, more particularly to agricultural pesticide compositions that comprise a deposition control agent

### BACKGROUND OF THE INVENTION

Many agricultural pesticides, including insecticides, fungicides, herbicides, miticides, and plant growth regulators, are applied in the form of a liquid composition. In addition to the pesticide and a solvent, such liquid compositions typically include one or more adjuvant compounds intended to improve one or more properties of the liquid composition, such as for example, storage stability, ease of handling, pesticide efficacy against target organisms.

Such agricultural pesticide compositions are typically applied to target plants by spraying. Spraying means are typically mounted on aircraft, tractors, ground rigs, irrigation systems or railcars. A spray may also be dispensed from a canister using mechanical means, such as a pump, or chemical means, such as a propellant.

In order to improve the deposition of the active ingredient on the target, and thereby in order to improve the efficacy of the spraying, the use of deposition aid agents is known. Deposition aid agents include drift control agents, anti-bouncing agents, anti-leaching agents, anti-misting agents, and mixtures thereof. Drift control agents are additives that, typically through control of droplet size, render spray droplets less susceptible to being blown off course and missing a target area. Anti-bouncing agents (also known as anti-rebound agents or sticking agents) are additives that render the spray droplets less susceptible to bouncing, rebounding, or splashing of the droplet when the droplet hits a target surface, for example a leaf, and thus reducing loss of active ingredient to the ground, Anti-leaching agents (also known as rain-fastness agents) are additives that, after deposition of droplets onto a target surface, render the spray droplets less susceptible to removal from the target surface by rain or wind and/or allowing a long lasting effect of the active. In each case, the deposition aid improves efficiency and permits a reduction of the amount of active ingredient used, which in turn reduces economical and environmental concerns.

U.S. Pat. No. 5,824,797 describes the use of certain guar compounds as drift-control agents and as bioefficacy enhancers, in agricultural spray compositions. U.S. Pat. No. 6,534,563 describes the use of certain polysaccharides, certain alkylenated derivatives of glycol, certain plant polymers, and certain synthetic polymers to improve the anti-rebound properties of plant protection formulations.

There is a continuing interest in agricultural pesticide compositions that exhibit improved properties.

### BRIEF SUMMARY OF THE INVENTION

In a fist aspect, the present invention relates to an aqueous agricultural pesticide composition, comprising:
(a) one or more water soluble or water dispersible deposition control agent, in an amount effective to provide improved anti-rebound properties and selected from:
   (i) dextrins and tamarind gums,
   (ii) derivatized polysaccharide hydrocolloids, except derivatized guars, having a molecular substitution of greater than or equal to about 0.1,
   (iii) proteinaceous hydrocolloids,
   (iv) lignins, except alkali metal, alkaline earth metal or ammonium lignosulphonates, and
   (v) lipid polymers, and
(b) an effective amount of a pesticide.

In a second aspect, the present invention is directed to a method for treating a target plant, comprising applying the above described pesticide composition to such plant.

In a third aspect, the present invention is directed to a method for improving the anti-rebound properties of an aqueous agricultural pesticide composition, comprising adding to the aqueous agricultural pesticide composition one or more water soluble or water dispersible deposition control agent, in an amount effective to provide improved anti-rebound properties and selected from:
(i) dextrins and tamarind gums,
(ii) derivatized polysaccharide hydrocolloids, except derivatized guars, having a molecular substitution of greater than or equal to about 0.1,
(iii) proteinaceous hydrocolloids,
(iv) lignins, except alkali metal, alkaline earth metal or ammonium lignosulphonates, and
(v) lipid polymers.

The compositions of the present invention exhibit improved anti-rebound properties, as indicated by reduced retraction speed upon impact of a drop of the composition with a surface. Without wishing to be bound by theory, it is believed that reduction in retraction speed is an indication that the kinetic energy of the droplet is more effectively dissipated upon impact of the droplet the target surface.

### BRIEF DESCRIPTION OF THE DRAWINGS

FIG. 1 illustrates a drop on a surface and the characteristics describing the drop impact.

FIG. 2 illustrates the determination of drop retraction speed.

### DETAILED DESCRIPTION OF THE INVENTION

As used herein, the term “water dispersible” in reference to a material means that the material capable of forming a solid-in-liquid dispersion in water, more typically, capable of forming a stable solid-in-liquid dispersion in water.

Suitable dextrins are known materials made by the hydrolysis of a starch by treatment of such starch with dilute acid or by heating the dry starch.

Suitable tamarind gums are known polysaccharide hydrocolloids derived from the seeds of the tamarind tree.

Suitable derivatized polysaccharide hydrocolloids are derivatized polysaccharide-based hydrophilic colloidal materials, except derivatized guars, having a molecular substitution of greater than or equal to about 0.1, as well as salts thereof, and include, for example, agar derivatives, alginate derivatives, amylose derivatives, arabica/acacia gum derivates, arabinogalactan derivatives, carob gum derivatives, cassia gum derivatives, cellulose derivatives, chitin derivatives, dextran derivatives, dextrin derivatives, gelan gum derivatives, ghatti gum derivatives, karaya gum derivatives, levan derivatives, locust bean gum derivatives, pectin derivatives, pullulan derivatives, rhamsan gum derivatives, starch derivatives, succinoglucan derivatives, tamarind gum derivatives, tara gum derivatives, tragacanth gum derivatives, and xanthan gum derivatives, and salts thereof.

In each case, suitable derivatized polysaccharide hydrocolloids include, for example, alkylated derivatives such as methyl cellulose, carboxalkylated derivatives such as a carboxyalkylated cassia gum, carboxymethyl cellulose, and carboxymethyl starches, cyanoalkylated derivatives such as a cyanoethyl cellulose, and cyanoethyl pullulan, hydroxyalkylated derivatives such as hydroxypropylated cassia gum, and hydroxypropyl chitosan. In one embodiment, the one or more derivatized polysaccharide hydrocolloid is derivatized with two or more different derivatizing groups, such as hydroxypropyl methyl cellulose.

In one embodiment, the one or more derivatized polysaccharide hydrocolloid comprises one or more derivatizing groups selected from hydrophobic groups. In one embodiment, the one or more derivatizing groups are selected from hydrocarbon groups, more typically saturated or unsaturated (C₁-C₁₈)hydrocarbon groups, even more typically (C₂-C₁₈)alkyl groups, and still more typically (C₂-C₈)alkyl groups, hydroxyalkyl groups, more typically hydroxy(C₂-C₈)alkyl groups, carboxyalkyl groups, more typically carboxy(C₂-C₈)alkyl groups, and cyanoalkyl groups, more typically cyano(C₂-C₈)alkyl groups, and mixtures thereof. Suitable hydrocarbon groups include, for example, ethyl, propyl, propylene, butyl, octyl, and decyl. Suitable hydroxyalkyl groups include, for example, ethoxyl, propoxyl, and butoxyl. Suitable carboxyalkyl groups include, for example, carboxyethyl and carboxypropyl. Suitable cyanoalkyl groups include, for example, cyanoethyl, cyanopropyl, and cyanobutyl. In one embodiment, the derivatizing groups further comprise hydroxyalkyltrimethylammonium groups. Suitable hydroxyalkyltrimethylammonium groups include, for example, hydroxypropyltrimethylammonium groups.

As used herein, the term “molecular substitution” of a derivatized polymer means the number of derivatizing groups per monomeric unit of the polymer. The molecular substitution of a derivatized polysaccharide hydrocolloid means the number of derivatizing groups per monosaccharide unit of the polysaccharide hydrocolloid. Molecular substitution can be determined by the Zeisel-GC method, based on the following literature reference: K. L. Hodges, * W. E. Kester, D. L. Wiederrich, and J. A. Grover, “Determination of Alkoxyl Substitution in Cellulose Ethers by Zeisel-Gas Chromatography”, Analytical Chemistry, Vol. 51, No. 13, November 1979. When using this method the following gas chromatograph conditions can be used:

| | |
|---|---|
| Column | DB-1 (30 m × 0.32 mm ID × 1.0 μm film thickness) |
| Program | 75 degrees Celsius-300 degrees Celsius at 25 |
| | degrees ° C./min (hold at 75° C. for 5 minutes) |
| Detector | Flame Ionization |
| Injector/Detector | 250/320° C. |
| Temperature | |
| Carrier gas Flow | Helium ˜1 ml/min |
| Split flow | Helium ˜20 ml/min |
| Injection volume | 1 microliter. |

In one embodiment, the derivatized polysaccharide hydrocolloid has a molecular substitution of greater than or equal to or equal to about 0.2, more typically greater than or equal to about 0.6, even more typically greater than or equal to or equal to 0.8, still more typically greater than or equal to or equal to 1.1, and even more typically greater than or equal to or equal to 1.2.

Suitable proteinaceous hydrocolloids include protein-based hydrophilic colloidal materials and derivatives of such materials, such as, for example, casein gum, casein derivatives, gelatin, and gelatin derivatives. In one embodiment, the deposition agent component of the pesticide composition of the present invention comprises one or more compounds selected from gelatins and gelatin derivatives, more typically, from gelatins.

Suitable lignins are water dispersible phenylpropane polymers of an amorphous structure that typically comprise from about 17% to about 30% woody, that is, cellulosic, material and derivatives of such materials. except alkali metal, alkaline earth metal or ammonium lignosulphonates, such as, for example, lignins, hydroxypropyl lignins, and butanol lignins.

Suitable lipid polymers include those water soluble or water dispersible polymers that comprise monomeric units bearing at least one saturated or unsaturated (C₄-C₂₄) hydrocarbon substituent group, more typically bearing a saturated or unsaturated (C₈-C₁₈)hydrocarbon substituent group, and derivatives of such polymers, such as, for example, soya polymers and lecithin. In one embodiment, the deposition agent component of the pesticide composition of the present invention comprises a lecithin.

Suitable derivatized polysaccharide hydrocolloids, derivatized proteinaceous hydrocolloids, derivatized lignins and derivatized lipid polymers can, in each case, be made by known reactions, such as for example, esterification, or etherification of the hydroxyl functionalities of a polysaccharide hydrocolloid, proteinaceous hydrocolloid, lignin, or lipid polymer substrate.

Principle etherification reactions are carboxymethylation via monochloroacetic acid, hydroxyalkylation via ethylene oxide or propylene oxide, and quaternization with various quaternary amine compounds containing reactive epoxide or chloride sites.

Specific hydroxyalkylating agents include ethylene oxide, propylene oxide-1,2; butylene oxide-1,2; hexylene oxide-1,2; ethylene chlorohydrin; propylene chlorohydrin; and epichlorohydrin.

Specific carboxyalkylating agents include chloroacetic acid, chloropropronic acid, and acrylic acid.

Specific quaternary ammonium alkylating agents are such agents as 2,3-epoxypropyl trimethylammonium chloride, 3-chloro-2-hydroxypropyl trimethylammonium chloride and the like.

Grafted polysaccharide derivatives may be formed by the use of grafting reactions, either alone or in combination with other derivatization techniques described above.

In on embodiment, the deposition control agent component of the pesticide composition of the present invention has a molecular weight of from about 25,000 g/mol to about 30,000,000 g/mol, more typically, from about 50,000 g/mol to about 10,000,000 g/mol, even more typically from about 200,000 g/mol to about 5,000,000 g/mol and still more typically from about 1,000,000 g/mol to about 5,000,000 g/mol.

In the present specification, the term “molecular weight” of the deposition control agent refers to the weight average molecular weight measured using gas permeation chromatography.

In one embodiment, the pesticide composition of the present invention comprises from about 0.001 to about 10 percent by weight (“wt %”), more typically from about 0.001 to about 5 wt %, even more typically from about 0.001 to about 2 wt %, still more typically from about 0.01 to about 0.5 wt %, and even more typically from about 0.01 to about 0.1 wt %, of the deposition control agent.

In one embodiment, the aqueous agricultural pesticide composition may further comprise, in addition to the deposition control agent, one or more of derivatized guars, polysaccharide hydrocolloids, including guars, having a molecular substitution of less than about 0.1, alkali metal, alkaline earth metal or ammonium lignosulphonates, polyalkylenated derivatives of glycol, polymers obtained from at least one saturated or unsaturated monomer comprising one or more carboxylic groups, in the form of an acid, alkali metal salt ester or amide, or containing an amino or nitrile group, or comprising a heterocyclic group containing nitrogen, and copolymers obtained by reacting at least one of said monomers with at least one second hydrocarbon containing monomer having one or more ethylenically unsaturated bonds.

Compounds suitable as the pesticide component of the pesticide composition of the present invention are those biologically active compounds used to control agricultural pests and include, for example, herbicides, plant growth regulators, crop dessicants, fungicides, bacteriocides, bacteriostats, insecticides, and insect repellants. Suitable pesticides include, for example, triazine herbicides such as metribuzin, hexaxinone, or atrazine; sulfonylurea herbicides such as chlorsulfuron; uracils such as lenacil, bromacil, or terbacil; urea herbicides such as linuron, diuron, siduron, or neburon; acetanilide herbicides such as alachlor, or metolachlor; thiocarbamate herbicides such as benthiocarb, triallate; oxadiazolone herbicides such as oxadiazon; phenoxyacetic acids such as 2,4-D; diphenyl ether herbicides such as fluazifop, acifluorfen, bifenox, or oxyfluorfen; dinitro aniline herbicides such as trifluralin; organophosphonate herbicides such as glyphosate salts and esters; dihalobenzonitrile herbicides such as bromoxynil, or ioxynil, dipyridilium herbicides such as paraquat. Suitable fungicides include, for example, nitrilo oxime fungicides such as cymoxanil; imidazole fungicides such as benomyl, carbendazim, or thiophanate-methyl; triazole fungicides such as triadimefon; sulfenamide fungicides, such as captan; dithio-carbamate fungicides such as maneb, mancozeb, or thiram; chloronated aromatic fungicides such as chloroneb; dichloro aniline fungicides such as iprodione, strobilurin fungicides such as kresoxim-methyl, trifloxystrobin or azoxystrobin; chlorothalonil; copper salt fungicides such as copper oxychloride; sulfur; phenylamides; and acylamino fungicides such as metalaxyl or mefenoxam. Suitable insecticides, include, for example, carbamate insecticides, such as methomyl, carbaryl, carbofuran, or aldicarb; organo thiophosphate insecticides such as EPN, isofenphos, isoxathion, chlorpyrifos, or chlormephos; organophosphate insecticides such as terbufos, monocrotophos, or terachlorvinphos; perchlorinated organic insecticides such as methoxychlor; synthetic pyrethroid insecticides such as fenvalerate, abamectin or emamectin benzoate, neonicotinoide insecticides such as thiamethoxam or imidacloprid; pyrethroid insecticides such as lambda-cyhalothrin, cypermethrin or bifenthrin, and oxadiazine insecticides such as indoxacarb, imidachlopryd, or fipronil. Suitable miticides include, for example, propynyl sulfite miticides such as propargite; triazapentadiene miticides such as amitraz; chlorinated aromatic miticides such as chlorobenzilate, or tetradifan; and dinitrophenol miticides such as binapacryl. Suitable nematicides include carbamate nematicides, such as oxamyl.

Pesticide compounds are, in general, referred herein to by the names assigned by the International Organization for Standardization (ISO). ISO common names may be cross-referenced to International Union of Pure and Applied Chemistry (“IUPAC”) and Chemical Abstracts Service (“CAS”) names through a number of sources such as, for example, the Compendium of Pesticide Common Names, which is available on-line at http://www.hclrss.demon.co.uk/index.html.

In one embodiment, the pesticide component of the pesticide composition of the present invention comprises one or more compounds selected from herbicides, plant growth regulators, crop dessicants, fungicides, bacteriocides, bacteriostats, insecticides, miticides, nematocides, insect repellants and mixtures thereof.

In one embodiment, the pesticide component of the pesticide composition of the present invention is selected from glufosinate, glyphosate, water soluble glufosinate salts, water soluble glyphosate salts, and mixtures thereof. Suitable water soluble glufosinate salts and water soluble glyphosate salts include in each case, the sodium, potassium, isopropyl amine, and ammonium salts of such compounds.

In one embodiment, the pesticide component of the pesticide composition of the present invention is selected from, the potassium salt of glyphosate, the sodium salt of glyphosate, the isopropyl amine salt of glyphosate, the ammonium salt of glyphosate, and mixtures thereof.

Herbicidal compositions containing glyphosate or derivatives thereof are used to control a very wide variety of plants worldwide and can, when applied to the target plant in a herbicidally effective amount, reportedly control one or more target plant species of one or more of the following genera: Abutilon, Amaranthus, Artemisia, Asclepias, Avena, Axonopus, Borreria, Brachiaria, Brassica, Bromus, Chenopodium, Cirsium, Commelina, Convolvulus, Cynodon, Cyperus, Digitaria, Echinochloa, Eleusine, Elymus, Equisetum, Erodium, Helianthus, Imperata, lpomoea, Kochia, Lolium, Malva, Oryza, Ottochloa, Panicum, Paspalum, Phalaris, Phragmites, Polygonum, Portulaca, Pteridium, Pueraria, Rubus, Salsola, Setaria, Sida, Sinapis, Sorghum, Triticum, Typha, Ulex, Xanthium and Zea, including annual broadleaf species such as, for example, velvetleaf (Abutilon theophrasti), pigweed (Amaranthus spp.), buttonweed (Borreria spp.), oilseed rape, canola, indian mustard, etc. (Brassica spp.), commelina (Commelina spp.), filaree (Erodium spp.), sunflower (Helianthus spp.), morningglory (Ipomoea spp.), kochia (Kochia scoparia), mallow (Malva spp.), wild buckwheat, smartweed, etc. (Polygonum spp.), purslane (Portulaca spp.), russian thistle (Salsola spp.), sida (Sida spp.), wild mustard (Sinapis arvensis) and cocklebur (Xanthium spp.), annual narrowleaf species such as for example, wild oat (Avena fatua), carpetgrass (Axonopus spp.), downy brome (Bromus tectorum), crabgrass (Digitaria spp.), barnyardgrass (Echinochloa crus-galli), goosegrass (Eleusine indica), annual ryegrass (Lolium multiflorum), rice (Oryza sativa), ottochloa (Ottochloa nodosa), bahiagrass (Paspalum notatum), canarygrass (Phalaris spp.), foxtail (Setaria spp.), wheat (Triticum aestivum) and corn (Zea mays), perennial broadleaf species such as, for example, mugwort (Artemisia spp.), milkweed (Asclepias spp.), canada thistle (Cirsium arvense), field bindweed (Convolvulus arvensis) and kudzu (Pueraria spp.), perennial narrowleaf species such as for example, brachiaria (Brachiaria spp.), bermudagrass (Cynodon dactylon), yellow nutsedge (Cyperus esculentus), purple nutsedge (C. rotundus), quackgrass (Elymus repens), lalang (Imperata cylindrica), perennial ryegrass (Lolium perenne), guineagrass (Panicum maximum), dallisgrass (Paspalum dilatatum), reed (Phragmites spp.), johnsongrass (Sorghum halepense) and cattail (Typha spp.), and other perennial species such as, for example, horsetail (Equisetum spp.), bracken (Pteridium aquilinum), blackberry (Rubus spp.) and gorse (Ulex europaeus).

As used herein, the terminology “effective amount” in reference to the relative amount of a pesticide in a pesticide composition means the relative amount of pesticide that is effective to control a target pest, for example, a target plant, fungus, bacterium, or insect, when the pesticide composition is applied at a given application rate.

In one embodiment, the pesticide component of the pesticide composition of the present invention is glyphosate herbicide and the pesticide composition is an herbicide composition that comprises a herbicidally effective amount of glyphosate.

As used herein, the terminology “an herbicidally effective amount” in reference to the relative amount of herbicide in an herbicidal composition means the relative amount that is effective to control growth of a target plant when the herbicidal composition is spray applied to the target plant at a given application rate.

In one embodiment, the pesticide composition further comprises one or more surfactants. The surfactant usually helps in formulating the active ingredient in the spray composition. However the surfactant might modify the affinity of the composition for the surface of the target, for example a leaf. Without being bound to any theory it is believed that invention is at least partly connected to controlling the affinity modification.

Various surfactants, or combinations of surfactants, can be present in the composition. The surfactants include anionic, nonionic, cationic, amphoteric, and zwitterionic surfactants, and mixtures thereof.

Anionic surfactants that are suitable for the spray composition according to the invention include:

phosphoester surfactants;

alkylsulphonic acids, arylsulphonic acids, possibly substituted with one of more hydrocarbon-containing groups, wherein the acid function is partially or completely in the salt form, such as C₈-C₅₀ alkylsulphonic acids, more particularly C₈-C₃₀, preferably C₁₀-C₂₂, benzenesulphonic acids, naphthalenesulphonic acids, substituted with one to three C₁-C₃₀ alkyl groups, preferably C₄-C₁₆, and/or C₂-C₃₀, preferably C₄-C₁₆ alkenyl;

mono- or di-esters of alkylsulphosuccinic acids, wherein the linear or branched alkyl portion may be substituted by one or more linear or branched C₂-C₄ hydroxyl and/or alkoxyl groups (preferably ethoxylated, propoxylated, ethopropoxylated);

phosphate esters, more particularly selected from those comprising at least one saturated, unsaturated or aromatic, linear or branched hydrocarbon group containing 8 to 40 carbon atoms, preferably 10 to 30, possibly substituted by at least one alkoxylated group (ethoxylated, propoxylated, ethopropoxylated) (Further, they comprise at least one phosphate ester group, mono- or di-esterified such that it is possible to have one or two acid groups that are free or completely or partially in the salt form. Preferred phosphate esters are of the following type: alkoxylated (ethoxylated and/or propoxylated ) mono- or di-esters of phosphoric acid and: mono-, di- or tri-styrylphenol, or mono-, di- or tri-alkylphenol, possibly substituted by one to four alkyl groups; or a C₈-C₃₀ alcohol, preferably C₁₀-C₂₂; or non-alkoxylated mono- or di-esters of phosphoric acid and a C₈-C₂₂ alcohol, preferably C₁₀-C₂₂);

sulphate esters obtained from saturated or aromatic alcohols, possibly substituted by one or more alkoxylated groups (ethoxylated, propoxylated, ethopropoxylated), and for which the sulphate functions are in the form of the free acid or are partially or completely neutralized (Examples that can be cited are sulphate esters, more particularly obtained from saturated or unsaturated C₈-C₂₀ alcohols, which may contain 1 to 8 alkoxylated groups (ethoxylated, propoxylated, ethopropoxylated));

sulphate esters obtained from polyalkoxylated phenol, substituted by 1 to 3 saturated or unsaturated C₂-C₃₀ hydroxycarbon-containing groups, and in which the number of alkoxylated motifs is in the range 2 to 40;

sulphate esters obtained from polyalkoxylated mono-, di- or tri-styrylphenol in which the number of alkoxylated motifs is in the range 2 to 40; and

oleoyltaurate salts.

It should be noted that in the case where the compounds are partially or completely in the salt form, the counter-ion can be an alkali metal such as sodium or potassium, or an ammonium ion with formula N(R)₄⁺where R, which may be identical or different, represents a hydrogen atom or a C₁-C₄ alkyl radical which may be substituted by an oxygen atom.

Nonionic surfactants that are suitable for the spray composition according to the invention include:

polyalkoxylated (ethoxylated, propoxylated, ethopropoxylated) phenols substituted by at least one C₄-C₂₀ alkyl radical, preferably C₄-C₁₂, or substituted by at least one alkylaryl radical wherein the alkyl portion is C₁-C₆ (More particularly, the total number of alkoxylated motifs is in the range 2 to 100. Examples that can be cited are polyalkoxylated mono-, di- and tri-(phenylethyl) phenols or polyalkoxylated nonylphenols);

C₆-C₂₂ fatty alcohols or acids that may be polyalkoxylated (ethoxylated, propoxylated, ethopropoxylated). When present, the number of alkoxylated motifs is in the range 1 to 60 (The term “ethoxylated fatty acid” includes both products obtained by ethoxylation of a fatty acid by ethylene oxide and those obtained by esterification of a fatty acid by a polyethylene glycol);

polyalkoxylated (ethoxylated, propoxylated, ethopropoxylated) triglycerides of plant or animal origin. (The following are suitable: triglycerides from lard, tallow, peanut oil, butter oil, cottonseed oil, linseed oil, olive oil, palm oil, grapeseed oil, fish oil, soya oil, castor oil, rapeseed oil, coprah oil, coconut oil, and with a total number of alkoxylated motifs in the range 1 to 60. The term “ethoxylated triglyceride” encompasses both products obtained by ethoxylation of a triglyceride by ethylene oxide and those obtained by transesterification of a triglyceride using a polyethylene glycol);

polyalkoxylated (ethoxylated, propoxylated, ethopropoxylated) sorbitan esters, more particularly esters of sorbitol cyclized with C₁₀ to C₂₀ fatty acids such as lauric acid, stearic acid or oleic acid, and with a total number of alkoxylated motifs in the range 2 to 50;

alkylpolyglucosides;

silicone based surfactants;

ethoxypropoxy copolymers; and

ethoxy and ethoxypropoxy fatty amines and/or ether amines.

Amphoteric or zwitterionic surfactants that are suitable for suitable for the spray composition according to the invention include:

betaines, such as sulfobetaines (sultaines), carboxybetaines (regular betaines), phosphobetaines, preferably alkylbetaines or alkylamidobetaines, for examples compounds having one or more of the following formulae:

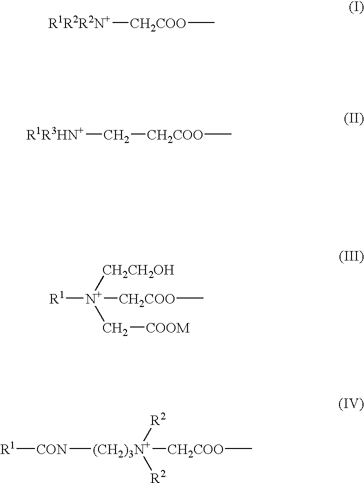

in which formulae:
R¹ represents a linear or branched alkyl group containing 3 to 30 carbon atoms, preferably 3 to 20 carbon atoms, such as propyl, decyl, dodecyl, tetradecyl, hexadecyl, tetrahexadecyl, octyl, or mixtures thereof, or an alkamide group, such as dodecanamide;
R², which may or may not be identical, represent an alkyl radical, preferably a methyl radical;
R³ represents a hydrogen atom or a —CH₂COOM radical or an alkyl radical;
M represents an alkali metal, preferably sodium,

alkylamidoamphoacetates,

alkylamphoacetates, and

amine oxides, optionally poly alkoxylated.

In one embodiment, the concentration of surfactant present in the spray composition can be of at least twice the critical micellar concentration in water. One skilled in the art knows how to measure the critical micellar concentration. These data are also available in literature, for example in “Industrial Utilization of Surfactants” by Manilal Dahanayake and Milton J. Rosen (AOCS Press).

In one embodiment, the spray composition comprises from about 0.01 wt % to 5 wt % surfactant, more typically from about 0.05 wt % to 2 wt % surfactant, wherein these amount refer to the total amount of all surfactants in the composition.

As used herein, the term “aqueous” in reference to a composition means that the composition comprises water. In one embodiment, the spray composition of the present invention comprises greater than or equal to about 20 wt %, more typically, greater than or equal to 50 wt %, even more typically greater than or equal to 80 wt %, water.

The spray compositions comprising agrochemical active can further comprise one or more the following ingredients, additional drift control agents, anti-foaming agents, anti-leaching agents, rheology modifiers, such as glycol and ethylene glycol, humectants, such as glycerine or glycol, fertilizers, such as 30-O-0, penetrants and/or spreading agents, such as silicones, vegetable or petroleum oils, solvents, methylated seed oils, chelators and water conditioners, such as citric acid, EDTA and inorganic salts like ammonium sulfate, ammonium phosphate and urea, and/or acrylates and methacrylates polymers.

The composition can be ground sprayed, aerial sprayed, or otherwise discharged in the form of droplets. In one embodiment, the composition is applied by discharging the composition through a spray nozzle. In one embodiment, the pesticide composition discharged through the spray nozzle in the form of droplets that exhibit an average droplet size of from about 50 micrometers (“μm”) to about 5 millimeters (“mm”), more typically from about 150 μm to about 2 mm.

The droplet impact behavior of the composition of the present invention may be characterized using a photographic technique in which photographic images of spray droplets impacting a target surface are captured using a high speed camera, for example, a Phantom 5 Science Technology camera, that allows variation in the frame capture rate. This capture rate is varied according to the speed of impact of the drop. For example, for a droplet impact speed of about 3 meters per second (“m/s”) impact speed, a frame rate of 1000 frames per second is typically used.

A syringe, typically a 10 milliliter (“ml”) syringe, is filled and connected to a pump; the solution is pumped at a rate of from about 1 to about 3 milliliters per hour (“ml/h”) through silicon tubing equipped with a needle, typically a 21 gauge needle (0.38 mm outer diameter), to generate a stream of droplets, each typically of about 2 mm in diameter. The droplets of pesticide composition are projected onto a target surface (Parafilm™ polymer film) from a height of 50 centimeter (“cm”), which results in an impact speed of the drops of 3 m/s. Parafilm™ polymer film is useful as a model surface in order to mimic the waxy cuticle of a leaf surface. Droplet size is measured from the images captured by the camera by quantifying the number of pixels and converting the number of pixels into millimeters. This was also confirmed from measurements of the mass of a known number of drops collected and weighed.

As used herein, the term “D0” refers to initial drop diameter. This is the diameter of the drop before impacting the surface (units of mm). This is measured from images taken by the camera.

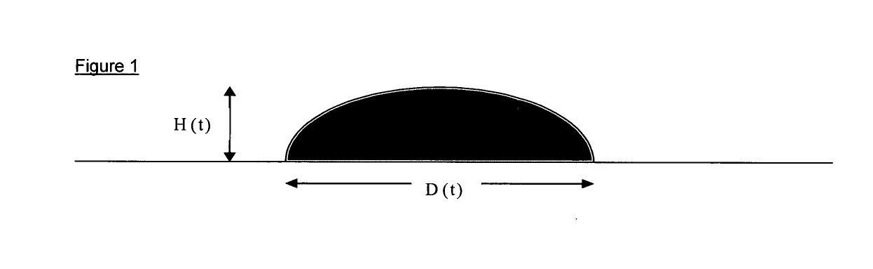

As used herein, the term “D(t)”—refers to the diameter of the drop on the surface during spreading and recoil when impacting the surface or after, as shown in FIG. 1 (units of mm). This measured from images taken by the camera.

As used herein, the term “H(t)”—refers to the height of the drop measured from the surface during spreading and recoil when impacting the surface or after, as shown in FIG. 1 (units of mm). This is measured from images taken by the camera.

Time measured from the moment of the drop impacting the surface in milliseconds (“ms”). This corresponds to the frame rate of the camera used to capture the images.

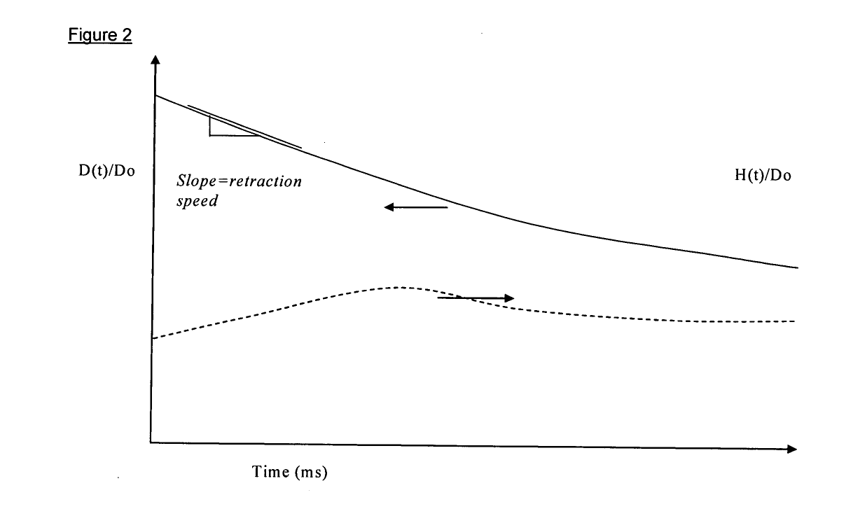

As used herein, the “retraction speed” of a drop impacting the surface means the slope of a curve obtained by plotting D(t)/D0 as a function of time, taken from the maximum in D(t)/D0, typically at 2 ms in the results presented here, until 10 ms, as shown in FIG. 2. The lower the retraction speed is, the better the deposition control is (for example, for anti-bouncing properties).

Performance can be measured by comparing the retraction speed of the drops (as defined above), where a polymer giving a lower retraction speed has a lower tendency to rebound. The critical retraction speed for rebound might depend on the characteristics of the impact, including the drop size, impact velocity and additives. By keeping the drop size and impact velocity constant, the effect of the added deposition control agent can be evaluated through comparing the retraction speeds of the drops. A performance of one deposition control agent is thereby compared with another.

The composition, the surfactant, the amount thereof, the deposition control agent, and/or the amount thereof are preferably such that the retraction speed is of lower than 200 mm/s.

1. An aqueous agricultural pesticide composition, comprising:
(a) a water soluble or water dispersible deposition control agent, in an amount effective to provide improved anti-rebound properties, selected from:
(i) dextrins and tamarind gums,
(ii) derivatized polysaccharide hydrocolloids, except derivatized guars, having a molecular substitution of greater than or equal to about 0.1,
(iii) proteinaceous hydrocolloids,
(iv) lignins and lignin derivatives, except alkali metal, alkaline earth metal or ammonium lignosulphonates, and
(v) lipid polymers, and
(b) an effective amount of a pesticide.

2. The composition of claim 1, wherein the deposition control agent has a weight average molecular weight of from about 25,000 g/mol to about 30,000,000 g/mol.

3. The composition of claim 1, wherein the pesticide composition comprises from about 0.001 to about 10 percent by weight of the deposition control agent.

4. The composition of claim 1, wherein the deposition control agent comprises one or more dextrins.

5. The composition of claim 1, wherein the deposition control agent comprises one or more tamarind gums.

6. The composition of claim 1, wherein the deposition control agent comprises one or more derivatized polysaccharide hydrocolloids, except derivatized guars, having a molecular substitution of greater than or equal to about 0.1.

7. The composition of claim 6, wherein one or more of the derivatized polysaccharide hydrocolloids comprises one or more hydrophobic derivatizing group selected from hydrocarbon groups, hydroxyalkyl groups, carboxyalkyl groups, and cyanoalkyl groups, per molecule of derivatized polysaccharide hydrocolloid.

8. The composition of claim 6, wherein the deposition control agent comprises one or more derivatized polysaccharide hydrocolloids selected from agar derivatives, alginate derivatives, amylose derivatives, arabica/acacia gum derivates, arabinogalactan derivatives, carob gum derivatives, cassia gum derivatives, cellulose derivatives, chitin derivatives, dextran derivatives, dextrin derivatives, gelan gum derivatives, ghatti gum derivatives, karaya gum derivatives, levan derivatives, locust bean gum derivatives, pectin derivatives, pullulan derivatives, rhamsan gum derivatives, starch derivatives, succinoglucan derivatives, tamarind gum derivatives, tara gum derivatives, tragacanth gum derivatives, xanthan gum derivatives, and salts thereof

9. The composition of claim 1, wherein the deposition agent comprises one or more proteinaceous hydrocolloids.

10. The composition of claim 6, wherein the deposition agent comprises one or more proteinaceous hydrocolloids selected from casein gum, casein derivatives, gelatin, and gelatin derivatives.

11. The composition of claim 1, wherein the deposition control agent comprises one or more one compounds selected from lignins and derivatized lignin, except alkali metal, alkaline earth metal or ammonium lignosulphonates.

12. The composition of claim 1, wherein the deposition control agent comprises one or more compounds selected from lipid polymers.

13. The composition of claim 1, wherein the pesticide comprises one or more compounds selected from herbicides, plant growth regulators, crop dessicants, fungicides, bacteriocides, bacteriostats, insecticides, miticides, nematocides, insect repellants.

14. The composition of claim 1, wherein the pesticide is selected from glufosinate, glyphosate, water soluble glufosinate salts, water soluble glyphosate salts, and mixtures thereof.

15. The composition of claim 1, wherein the pesticide is glyphosate herbicide and the pesticide composition is an herbicide composition that comprises a herbicidally effective amount of glyphosate.

16. The composition of claim 1, wherein the composition further comprises from about 0.01 wt % to 5 wt % of a surfactant.

17. The composition of claim 1, wherein surfactant is selected from anionic surfactants, nonionic surfactants, cationic surfactants, amphoteric surfactants, zwitterionic surfactants, and mixtures thereof.

18. The composition of claim 1, wherein the composition further comprises, in addition to the deposition control agent, one or more of derivatized guars, polysaccharide hydrocolloids having a molecular substitution of less than about 0.1, and alkali metal, alkaline earth metal or ammonium lignosulphonates, polyalkylenated derivatives of glycol, polymers obtained from at least one saturated or unsaturated monomer comprising one or more carboxylic groups, in the form of an acid, alkali metal salt ester or amide, or containing an amino or nitrile group, or comprising a heterocyclic group containing nitrogen, and copolymers obtained by reacting at least one of said monomers with at least one second hydrocarbon containing monomer having one or more ethylenically unsaturated bonds.

19. A method for treating a target plant, comprising applying the pesticide composition of claim 1 to such plant.

20. The method of claim 19, wherein the composition is applied by discharging the composition through a spray nozzle.

21. The method of claim 20, wherein pesticide composition discharged through the spray nozzle is in the form of droplets that exhibit an average droplet size of from about 50 micrometers to about 5 millimeters.

22. A method for improving the anti-rebound properties of an aqueous agricultural pesticide composition, comprising adding to the aqueous agricultural pesticide composition a water soluble or water dispersible deposition control agent selected from:
(i) dextrins and tamarind gums,
(ii) derivatized polysaccharide hydrocolloids, except derivatized guars, having a molecular substitution of greater than or equal to about 0.1,
(iii) proteinaceous hydrocolloids,
(iv) lignins, except alkali metal, alkaline earth metal, or ammonium lignosulphonates, and
(v) lipid polymers.
